(19) United States
(12) Patent Application Publication
(10) Pub. No.: US 2004/0130082 A1
(43) Pub. Date: Jul. 8, 2004

(54) Mechanical isolator

(76) Inventors: Wen-Yuan Tsai, Hsin-Tien City (TW); Yung-Chang Kang, Yung-Ho City (TW)

Correspondence Address: SUPREME PATENT SERVICES, POST OFFICE BOX 2339, SARATOGA, CA, 95070, US

(21) Appl. No.: 10/336,372

(22) Filed: Jan. 2, 2003

(51) Int. Cl. F16F 1/36

(52) U.S. Cl. 267/153

(57) ABSTRACT

An isolator mounts a first device, such as hard disk drive, to a second device, such as a computer. The isolator is received in a hole defined in the second device for supporting the first device. The isolator includes a cylinder having first and second ends connected by a circumferential outer surface. The cylinder defines a central bore having an inner surface. A flange is formed on and around the first end of the cylinder. A plurality of first ribs is formed on the inner surface and extends in an axial direction of the cylinder. Each first rib has first and second end sections respectively extending on an outside face of the flange and the second end of the cylinder. A plurality of second ribs is formed on the outer surface and extends from an inside face of the flange whereby the second ribs and the first end sections of the first ribs are located on opposite sides of the flange. The second ribs alternate the first ribs.

### FIELD OF THE INVENTION

The present invention relates generally to a mechanical isolator, and in particular to a mechanical isolator in the form of alternately-ribbed grommet.

### BACKGROUND OF THE INVENTION

Mechanical isolators have been widely used to isolate mechanical vibration between parts. One of the commonly used isolators is a grommet mounted between parts. The grommet has a short cylinder having a circumferential outer groove for mounting to a first part and a central bore for receiving a second part so as to mount the first part to the second part. The grommet may be made of a resilient material, such as rubber, for absorption and damping vibration of one of the first and second parts. Some of the grommets, referred to as ribbed grommet, have rib formed on and extending in an axial direction along a surface of the grommet for better isolation.

Conventionally, the grommet type isolator is mounted to a necked hole and is used in pair to ensure proper and secure positioning of the first part with respect to the second part. FIG. 1 of the attached drawings shows an application of the conventional grommet, wherein a rack 10 for mounting a computer hard disk drive to a computer casing (both not shown) is shown. The rack 10 defines two necked holes 12 each receiving an isolator (grommet) 14. The isolator 14 comprises a short cylindrical body (not labeled) having an outer circumferential surface 16 in which a circumferential groove 18 is defined. The necked hole 12 has a large opening section for insertion of the isolator 14 therein and a small opening section for engaging the groove 18 and securely retaining the isolator 14 in the hole 12. To eliminate undesired movement of the isolator 14 back to the large opening section of the hole 18, the two holes 18 are arranged in opposite manner. However, it requires precise tolerance to completely eliminate the movement of the isolators 14.

In addition, since the cylindrical body of the grommet or isolator is not fixed in a circumferential direction, when it is tightened by a bolt, the resilient body of the isolator is twisted. Such twisting influences the capability of shock absorption of the isolator and it is difficult to precisely assess the influence caused by the twisting.

### SUMMARY OF THE INVENTION

Thus, an object of the present invention is to provide a ribbed grommet type isolator that completely eliminates undesired movement of the isolator.

Another object of the present invention is to provide an isolator that securely retains parts in position without being used in pair.

To achieve the above objects, in accordance with the present invention, there is provided an isolator for mounting a hard disk drive to a computer casing. The isolator is received in a hole defined in the computer casing for supporting the hard disk drive. The isolator comprises a resilient cylinder having first and second ends connected by a circumferential outer surface. The cylinder defines a central bore having an inner surface. A flange is formed on and around the first end of the cylinder. A plurality of first ribs is formed on the inner surface and extends in an axial direction of the cylinder. Each first rib has first and second end sections respectively extending on an outside face of the flange and the second end of the cylinder. A plurality of second ribs is formed on the outer surface and extends from an inside face of the flange whereby the second ribs and the first end sections of the first ribs are located on opposite sides of the flange. The second ribs alternate the first ribs.

### BRIEF DESCRIPTION OF THE DRAWINGS

The present invention will be apparent to those skilled in the art by reading the following description of a preferred embodiment thereof, with reference to the attached drawings, in which:

FIG. 1 is a perspective view of a computer hard disk drive rack to which conventional isolators are mounted;

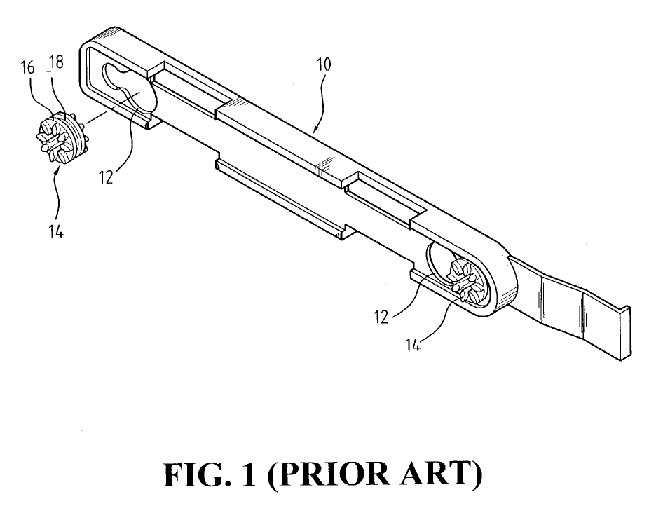

FIG. 2 is a perspective view of an isolator constructed in accordance with the present invention;

FIG. 3 is another perspective view of the isolator of the present invention;

FIG. 4 is a cross-sectional view of the isolator of the present invention;

FIG. 5 is a perspective view of a computer hard disk drive rack to which isolators in accordance with the present invention are mounted;

FIG. 6 is a perspective view of a computer hard disk drive cage to which the hard disk drive rack of FIG. 5 is mounted;

FIG. 7 is a perspective view of the computer hard disk drive rack showing a first side of the hole to which the isolator is mounted; and

FIG. 8 is an other perspective view of the computer hard disk drive rack showing a second side of the hole to which the isolator is mounted.

### DETAILED DESCRIPTION OF THE INVENTION

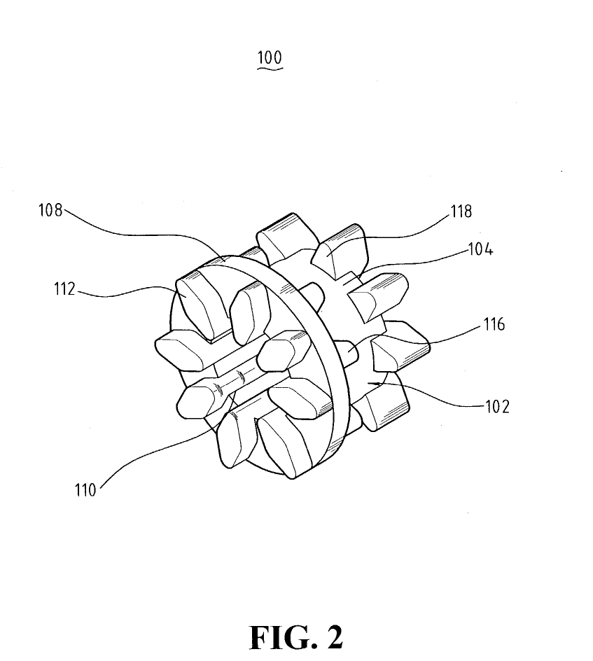

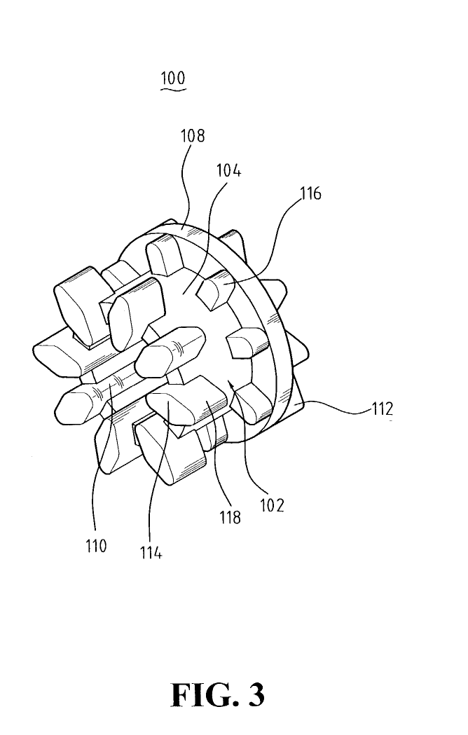

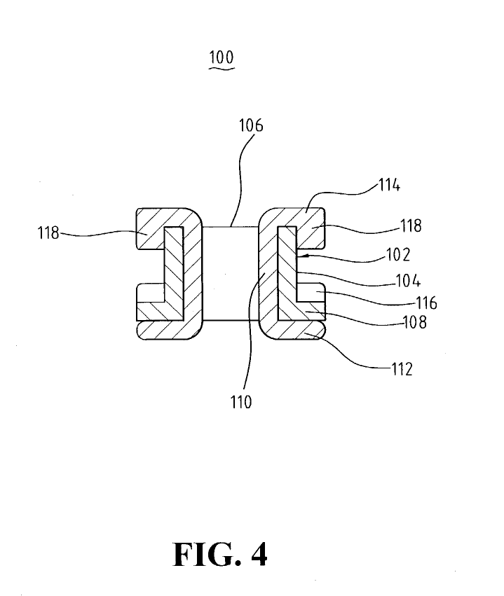

With reference to the drawings and in particular to FIGS. 2-4, an isolator constructed in accordance with the present invention, generally designated with reference numeral 100, comprises a cylinder 102 having an outer circumferential surface 104 and defining a central bore 106. A circumferential flange 108 is formed on and around an end of the cylinder 102. A plurality of first ribs 110 is formed on an inside surface of the bore 106 and extends in an axial direction of the cylinder 102. Each first rib 110 is C-shaped having perpendicular end sections 112, 114 formed on and radially extending along an outside face of the flange 108 and an opposite end of the cylinder 102. Each end section 114 of the first ribs 110 has an extension 118 along the outer surface 104 of the cylinder 102. The first ribs 110 are substantially equally spaced in a circumferential direction of the cylinder 102. A plurality of second ribs 116 is formed on the outer surface 104 of the cylinder 102 and extends from an inside face of the flange 108 whereby the second ribs 116 and the end sections 112 of the first ribs 110 are located on opposite sides of the flange 108 and the second ribs 116 are axially spaced from the extensions 118 of the first ribs 110. The second ribs 116 are arranged to alternate the first ribs 110 in the circumferential direction.

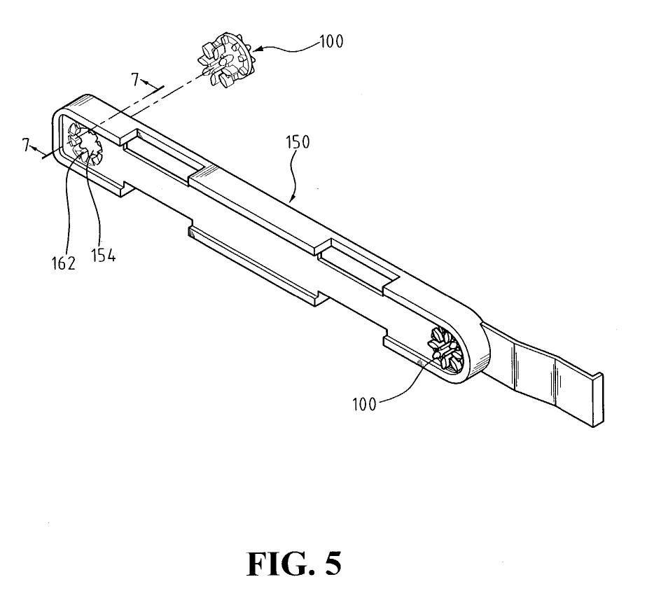

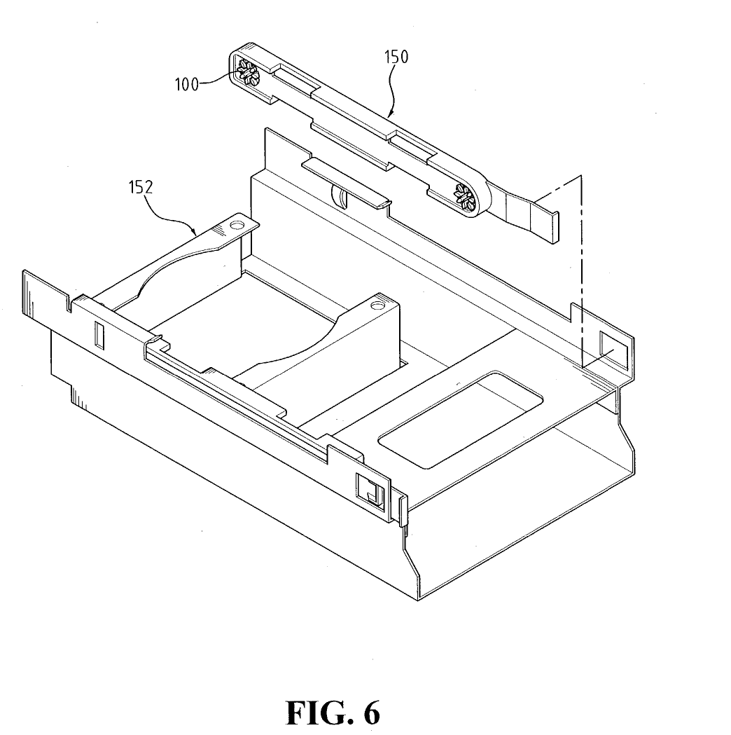

Also referring to FIGS. 5 and 6, an illustrative application of the isolator 100 of the present invention is shown, wherein two isolators 100 are mounted to a rack 150 for mounting a computer hard disk drive (not shown) to a hard disk drive cage 152. The isolators 100 isolate vibration between the rack 150 and the computer hard disk drive. The rack 150 defines two holes 154 for receiving and retaining the isolators 100.

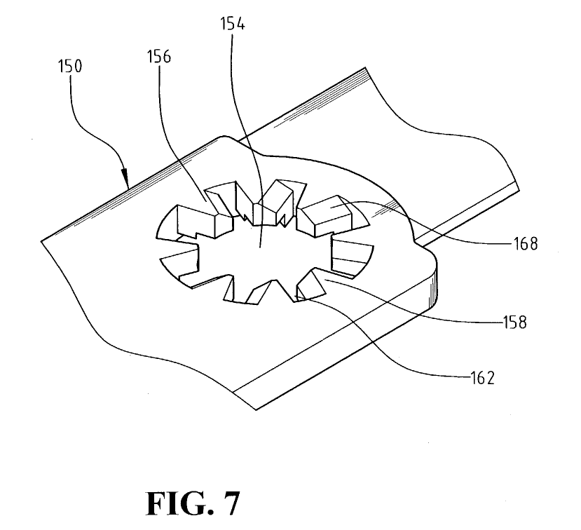

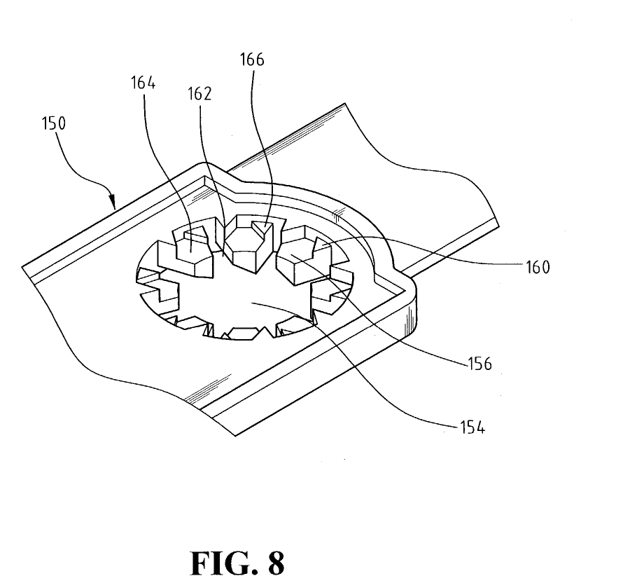

Also referring to FIGS. 7 and 8, a web 156 is formed on an inner surface of the hole 154 and has first and second faces 158, 160. A plurality of channels 162 is defined in the web 156 and divides the web 156 into spaced segments (not labeled). Each segment of the web 156 forms a notch or receptacle 164 on the second face 160.

To mount the isolator 100 to the hole 154, the extensions 118 of the first ribs 110 are fit into the channels 162 from the first face 158 until the second ribs 116 engage the first face 158 of the web 156. The isolator 100 is made of a resilient material, such as rubber, and is thus resilient. The resiliency of the isolator 100 allows the cylinder 102 to be twisted and deformed so as to allow the second ribs 116 that are not aligned with the extensions 118 of the first ribs 110 to be aligned with and inserted into the channels 162 until the flange 108 engages the first face 158 of the web 156. The web 156 has a thickness (that is the dimension in the axial direction) such that the extensions 118 of the first ribs 110 are allowed to enter and retain in the receptacles 164 of the second face 160 of the web 156 by being forced by returning spring force of the cylinder 102. The extensions 118 of the first ribs 110 and the flange 108 are thus located on opposite sides of the web 156 and respectively engage the second and first faces 160, 158 of the web 156. Thus, the isolator 100 is securely retained in the hole 154.

Each receptacle 164 has an open side for the entry of the extension 118 of the corresponding first rib 110. Preferably, a projection 166 is formed on the open side of the receptacle 164 for effective and secure retention of the extension 118 of the first rib 110 therein. In addition, the segments of the web 156 are provided with inclined faces 168 whereby each channel 162 that is located between adjacent segments of the web 156 has a diverging opening in the first face 158 of the web 160 for enhancing insertion of the ribs 110, 116 into the channels 162.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. An isolator comprising:
a cylinder having first and second ends connected by a circumferential outer surface, the cylinder defining a central bore having an inner surface;
first ribs formed on the outer surface and extending in an axial direction of the cylinder; and
second ribs formed on the outer surface of the cylinder and extending in the axial direction, the second ribs being axially spaced from the first ribs and circumferentially alternating the first ribs.

2. The isolator as claimed in claim 1, wherein the first ribs and the second ribs are equally spaced in a circumferential direction of the cylinder.

3. The isolator as claimed in claim 1, wherein the cylinder is resilient and thus deformable.

4. The isolator as claimed in claim 3, wherein the cylinder is made of rubber.

5. The isolator as claimed in claim 1, further comprising axially extending ribs formed on the inner surface of the central bore.

6. The isolator as claimed in claim 1, further comprising a flange formed on and around the first end of the cylinder, the second ribs axially extending from the flange.

7. The isolator as claimed in claim 1, further comprising radially extending ribs formed on first and second ends of the cylinder.

8. The isolator as claimed in claim 1, wherein each first rib comprises an inner section axially extending along the inner surface and a first radially extending end section formed on the first end of the cylinder and connecting between the first rib and the inner section, a second radially extending end section formed on the second end of the cylinder and connecting with each inner section.

9. A mounting system for mounting a first device in a second device comprising:
an isolator comprising:
a resilient cylinder having first and second ends connected by a circumferential outer surface, the cylinder defining a central bore having an inner surface for receiving a portion of the first device,
a plurality of first ribs formed on the outer surface and extending in an axial direction of the cylinder, and
a plurality of second ribs formed on the outer surface of the cylinder and extending in the axial direction, the second ribs being axially spaced from the first ribs and circumferentially alternating the first ribs; and
a mount member mounted to the second device and defining a hole for receiving and retaining the isolator therein, a circumferential web being formed in the hole and having first and second faces, a plurality of channels being defined in the web and extending in the axial direction between the first and second faces, the web being divided into spaced segments by the channels, each segment forming a receptacle in the second face thereof;
wherein the isolator is mounted to the hole by having the first ribs fit into the channels from the first face of the web until the second ribs engage the first face of the web, the cylinder being twisted and deformed to have the second ribs fit into the channels until the flange engages the first face of the web whereby the first ribs are forced into the receptacles by returning spring force of the cylinder thereby securely retaining the isolator in the hole.

10. The mounting system as claimed in claim 9, wherein the first ribs and the second ribs of the isolator are equally spaced in a circumferential direction of the cylinder.

11. The mounting system as claimed in claim 9, wherein the isolator is resilient and thus deformable.

12. The mounting system as claimed in claim 11, wherein the isolator is made of rubber.

13. The mounting system as claimed in claim 9, wherein the isolator further comprises axially extending ribs formed on the inner surface of the central bore of the cylinder.

14. The mounting system as claimed in claim 9, wherein the isolator further comprises a flange formed on and around the first end of the cylinder, the second ribs axially extending from the flange.

15. The mounting system as claimed in claim 9, wherein the isolator further comprises radially extending ribs formed on first and second ends of the cylinder.

16. The mounting system as claimed in claim 9, wherein each first rib of the isolator comprises an inner section axially extending along the inner surface of the cylinder and a first radially extending end section formed on the first end of the cylinder and connecting between the first rib and the inner section, a second radially extending end section formed on the second end of the cylinder and connecting with each inner section.
